(19) United States
(12) Patent Application Publication
(10) Pub. No.: US 2009/0325775 A1
(43) Pub. Date: Dec. 31, 2009

(54) METHOD FOR MANUFACTURING A BIOACTIVE GLASS CERAMIC MATERIAL

(76) Inventor: Nan-Hui Yeh, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/388,095

(22) Filed: Feb. 18, 2009

(30) Foreign Application Priority Data
Jun. 26, 2008 (TW) 097123860

(51) Int. Cl. C03C 14/00; C03C 3/32

(52) U.S. Cl. 501/32; 501/40

(57) ABSTRACT

A method for manufacturing a bioactive glass ceramic material is firstly to prepare a calcium phosphate series ceramic material and a nano-scaled titanium dioxide powder with a specific proportion of anatase type titanium dioxide structure. Then, the calcium phosphate series ceramic material and the nano-scaled titanium dioxide powder are mixed according to a specific proportion for obtaining a mixture. The mixture is then melted and quenched to form a biomedical glass. Finally, the biomedical glass can be further ground into a biomedical glass powder, and a heat treatment can be applied to recrystalize the powder so as to obtain the bioactive glass ceramic material. Also, the bioactive glass ceramic material can be further polarized into a electrified bioactive glass ceramic material which can promote the growth of a broken bone.

This application claims the benefit of Taiwan Patent Application Serial No. 097123860, filed Jun. 26, 2008, the subject matter of which is incorporated herein by reference.

### BACKGROUND OF THE INVENTION

1. Field of the Invention

The present invention relates to a method for manufacturing a bioactive glass ceramic material, and more particularly to a method which uses a calcium phosphate-series glass ceramic material and a nano-scaled titanium dioxide powder replete with an anatase-type titanium dioxide structure to manufacture the bioactive glass ceramic material. The material is further polarized and transferred so that a electrified bioactive glass ceramic material can be manufactured.

2. Description of Related Art

Bones to support a human body or an animal body consist of bone tissues and osteo-blasts. The bone tissues mainly include calcium phosphate-series compounds. Occasionally, some types of bones may have inherent defects, or may face ill-function obstacles from aging, damages or fatigues. In addition, some bone tissues may experience mechanical fatigue injury from an ignorable chronic work. Also, when a human body is subjected to a severe impact from an accident, the bone tissues may be seriously injured.

Bone damages, fissure or fracture, from aging, physical impact or fatigue injury usually happen to the inner structure of bones or joints. Even worse, some bone damage may have severe impact upon people's movement. In particular, sharp pieces of broken bones may pierce or cut neighboring tissues or organs. Definitely, it is painful for such an occasion to occur. Thus, emergency treatment is needed to stabilize the broken bones by a splint so that the following healing process can begin. In the art, the bone transplant is one of common therapies to heal the broken bones, and can be conventionally classified into a type of autografting and another type of allografting according to the source of bone graft for transplanting.

As to autografting, a new bone (hereinafter autograft) for grafting is obtained from other part of the same body. Generally speaking, the autografting is a safer and more efficient operation in bone transplant. However, for some damages, qualified bones in the same body for possible autografting may be limited. Further, senior people, children or some unhealthy individuals may not have a body condition well enough for a specific bone transplant. Due that an additional opening in the body and substantial operation risk are inevitable, the autografting usually makes patents uncomfortable both physically and mentally. Thus, when a bone damage is large and patents' mental and physical conditions are not in good shape, the patents are not eligible to be autografted.

As to allografting, the new bone for grafting (hereinafter allograft) is donated by some other people, in which the new bone is collected, stored and frozen in advance in a so-called “bone bank” (special facilities similar to a refrigerator). However, in practice, there are still some concerns on the allografting. For example, it is not sure if the quality of donated bones or the storage condition in the bone bank is all right. Also, it is concerned if the virus screening system of bone bank is good enough and meticulous (such as hepatitis or AIDS).

Obviously, it is proper to replace both the bone allografts and the bone autografts by new-technicbone graft substitutes. Following are some developments.

Mr. Larry L. Hench of University of Florida in 1970 firstly found and developed a (SiO₂—Na₂O—CaO—P₂O₅) bioglass which is composed of silicon dioxide (SiO₂), sodium oxide (Na₂O), calcium oxide (CaO), and phosphorus pentoxide (P₂O₅). By providing the bioglass, a bonding can be successfully formed in between with the natural bone tissues. Further, Bromer and his colleagues in Germany continued to develop the bioglass, and, in 1973, found that a new biolass called Ceravital® (SiO₂—Na₂O—CaO—P₂O₅—MgO—K₂O) consists of silicon dioxide (SiO₂), sodium oxide (Na₂O), calcium oxide (CaO), phosphorus pentoxide (P₂O₅), magnesium oxide (MgO), and potassium oxide (K₂O). In applying the Ceravital®, part of apatite in crystalline phase may be precipitated.

Recently, from some experiments, it is found that the apatite glass ceramic has a substantial high mechanical strength. When the apatite glass ceramic is used to replace or gives a bonding to human's bones, the apatite glass ceramic provides the patients with sufficient support to the original bones. Unfortunately, bioactivity on surface of the apatite glass ceramic is pretty low, and so it is currently seen in implanting the mandible.

After the bioglass is implanted into human's body, sodium ion (Na⁺) may be released so that a gel layer replete with silicon dioxide (SiO₂) can originate osteocytes accrues, and then the collagen fibers. Finally, because calcium ion (Ca⁺) and phosphorus ion (P⁵⁺) released from the bioglass are in vicinity of collagen fibers, a hydroxylapatite crystal is formed so as to give a bonding to bone. Meanwhile, the bioglass mentioned above is a kind of glass ceramics which has a good biocompatibility and can provide a bonding to host tissue. Clinically, the bioglass is usually applied to manufacture the bone graft, bioactive grout or implant coating etc.

As described above, the bone tissue is mainly formed of calcium phosphate compounds, and it is proper to replace bone allografts and bone autografts with bone graft substitutes that contain these compounds. Clinically, the bioglass is usually applied to manufacture the bone graft substitutes. To clarify related technology, the calcium phosphate (Ca₃(PO₄)₂), the calcium phosphate glass and the bioactive glass ceramic are explained in more details provided in the following.

The human bone is mainly formed of calcium phosphates which can be be absorbed by human body. The calcium phosphates are used as substitutes for bone filling and bone repair. Among all phosphates, beta-tricalcium phosphate (β-Ca₃(PO₄)₂) and apatite are called the third generation biomedical materials. Hydroxylapatite is easily transformed into beta-tricalcium phosphate (β-Ca₃(PO₄)₂) in high temperature. In particular, when the temperature is higher than 1180° C., the beta-tricalcium phosphate (β-Ca₃(PO₄)₂) will become the alpha-tricalcium phosphate (α-Ca₃(PO₄)₂). Density of the tricalcium phosphate will be then changed from 3.07 g/cm³ to 2.77 g/cm³.

Regarding the mechanical strength of beta-tricalcium phosphate (β-Ca₃(PO₄)₂), if the sintering temperature is higher than 1150° C., then a phase transformation will happen. If the sintering temperature is low, the porosity of beta-tricalcium phosphate (β-Ca₃(PO₄)₂) would be high. The mechanical strength of a pure sintered beta-tricalcium phosphate (β-Ca₃(PO₄)₂) is at most within the range from 200 to 400 MPa. Thus, it requires additives to enhance the mechanical strength of the beta-tricalcium phosphates (β-Ca₃(PO₄)₂).

Phosphoric acid glass consists of unit cells which are orthophosphate anions in a tetrahedral arrangement, and each of the orthophosphate anions is surrounded by three orthophosphate anions and bonded by cross linking. If an additive such as the calcium oxide (CaO) is added, then bonding of P—O—P will be broken, and the bonding density of the glass would be reduced so that the calcium phosphate glass can be formed.

The glass-ceramic is also called a crystalline glass and has a good bending strength and stable chemical properties. Composition of the calcium phosphate of the glass-ceramic is similar to that of any human bone, and, more importantly, the glass-ceramic has an excellent bio-affinity.

The glass-ceramic is generally a polycrystalline solid material in glass phase. In manufacturing, a glass batch is firstly melt and poured into a specific plate. Then, the melt glass batch in the specific plate is subjected to a heat treatment for a “controlled crystallization” to form a solid polycrystalline material.

When the glass-ceramic is applied to biotherapy, the glass-ceramic is called a bioactive glass ceramic. Unlike other glass ceramics, the bioactive glass ceramic (especially applied for bone transplant) must be adapted to different environments and have versatile applications due to its excellent physical properties. In addition, the bioactive glass ceramic is biocompatible and bioactive, and provides a good chemical bonding between vascularized tissues and non-vascularized tissues. The bioactive glass ceramic has no adverse impact on human body after the bioactive glass ceramic has been implanted. Meanwhile, some new-generation bioactive ceramics are prone to provide bonding to bone or to be reactive to bone. Further, the bioactive ceramics may help the healing of the broken bone and become finally as a part of tissues to the human body.

Practically, the bioactive glass ceramics are usually made of some calcium phosphate series ceramic materials such as hydroxyapatite (HA), dicalcium phosphates (DCP), and tricalcium phosphates (TCP) etc. These calcium phosphate series ceramic materials provide ceramic properties but with good biocompatibility. However, these materials have two minor shortcomings. Firstly, these materials do not have good mechanical strength, from which only limited application can be expected. Generally speaking, these materials are merely applied to medical usage which only needs to carry smaller loading, such as the dental implant. Secondly, when these materials have been implanted into human's body, most of them provide no help in healing of the broken bones.

### SUMMARY OF THE INVENTION

Accordingly, the present invention provides a method for manufacturing a bioactive glass ceramic material that can provide substantially required mechanical strength and improve the healing schedule of a broken bone. The bioactive glass ceramic material of the present invention is polarized so as to transfer into an electrified bioactive glass ceramic material which can be used as a bone graft able to promote the growth of bones.

It is another object of the present invention to provide a method for manufacturing a bioactive glass ceramic material, which utilizes a heat treatment and a recrystallization process to enhance mechanical strength of the bioactive glass ceramic material.

To overcome aforesaid disadvantages of the prior art, the present invention provides a method for manufacturing a bioactive glass ceramic material. The method provides a calcium phosphate series glass ceramic material and a nano-scaled titanium dioxide powder which includes a predetermined proportion of anatase type titanium dioxide structure. Then, according to a predetermined mixing proportion, the calcium phosphate series glass ceramic material is mixed with the nano-scaled titanium dioxide powder so as to obtain a mixture.

The mixture is then melt and quenched so as to form a bioactive glass. The bioactive glass is further ground into a bioactive glass powder with predetermined acceptable grain sizes. The bioactive glass powder of the present invention can be recrystallized after a heat treatment so as to manufacture the bioactive glass ceramic material with a better mechanical strength.

According to one embodiment of the present invention, an electric field can be implemented to polarize the bioactive glass ceramic material so as to produce an electrified bioactive glass ceramic material.

In contrast to the bioactive glass ceramic material consisting of calcium phosphate series in the prior art, the bioactive glass ceramic material of the present invention mainly includes the nano-scaled titanium dioxide powder with a predetermined proportion of anatase type titanium dioxide structure. In this light, a bone graft which is made of the instant bioactive glass ceramic material can be transplanted into human body so as to promote the healing as well as the growth of the broken bones, and thus the recovery duration for patients can be also improved.

In addition, by providing the present invention, the bending strength of the bioactive glass ceramic material can be also increased by two (2) to four (4) times of that of the prior art. Thus, after the bioactive glass ceramic material of the present invention is implanted into human body, the bioactive glass ceramic material can expedite the recovery of the broken bone so as to help people back to normal life as soon as possible.

### BRIEF DESCRIPTION OF THE DRAWINGS

The present invention can be fully understood from the following detailed description and preferred embodiment with reference to the accompanying drawings, in which:

FIGS. 1 and 1A are flow charts of embodiments of the present invention;

FIG. 2 is a comparison table between the bending strength of the bioactive glass ceramic material of the prior art and that of the bioactive glass ceramic material of the present invention;

FIG. 3 is a comparison table of dielectric constants and mechanical property factors of the non-polarized and polarized bioactive glass ceramic materials of the present invention;

FIG. 4 is a comparison table of cell survival between the present invention and the prior art; in which, by comparing to the prior art, the electrified bioactive glass ceramic material is subjected to a cell survival (MTT) assay by four hours;

FIG. 5 is another comparison table of cell survival between the present invention and the prior art; in which, by comparing to the control group, the electrified bioactive glass ceramic material is subjected to the cell survival (MTT) assay by 96 hours;

FIG. 6 is an embodiment of the present invention showing how the broken bone grows and recovers since the non-polarized bioactive glass ceramic material has been transplanted into rabbit's body; and

FIG. 7 illustrates another embodiment of the present invention showing how the broken bone grows and recovers since the polarized bioactive glass ceramic material has been transplanted into rabbit's body.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The bioactive glass ceramic material of the present invention is extensively applied to a variety of applications, and the bioactive glass ceramic material is used as a bone graft so as to promote growth of a broken bone toward recovering. Alternatives of the present invention are possible and without detailed description. T he examples are provided to illustrate general principles of embodiments of the present invention.

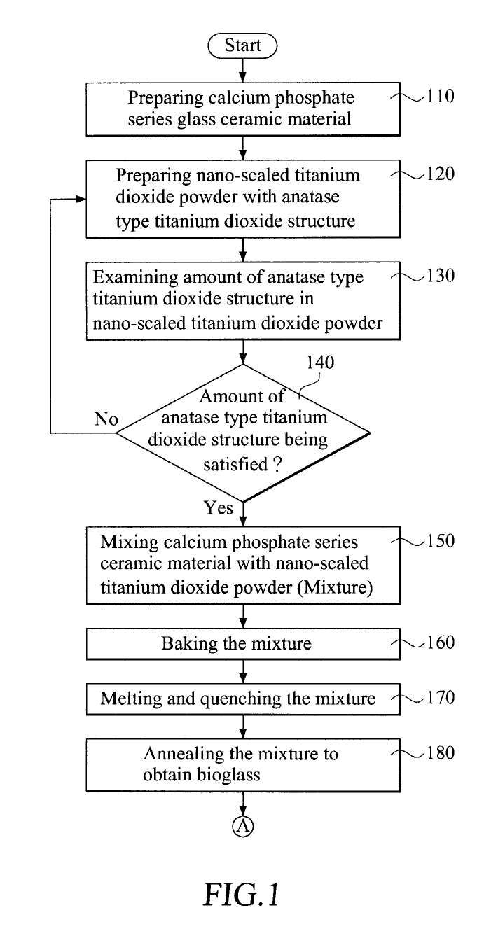

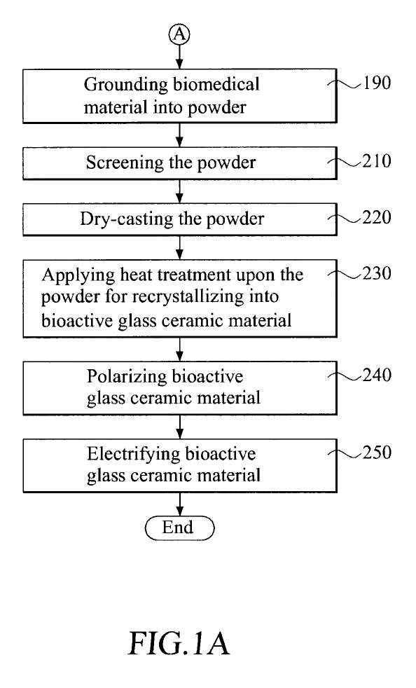

Referring to FIGS. 1 and 1A, flowcharts of respective embodiments of the present invention are illustrated. As shown in FIGS. 1 and 1A, the present invention provides a calcium phosphate series ceramic material. Preferably, the calcium phosphate series ceramic material is manufactured by mixing the calcium oxide (CaO), the phosphorus pentoxide (P₂O₅) and the phosphoric acid (H₃PO₄) (Step 110). Meanwhile, the present invention prepares a nano-scaled titanium dioxide powder with a specified proportion of anatase type titanium dioxide structure (Step 120).

Because the nano-scaled titanium dioxide powder with anatase type titanium dioxide structure is easy to be polarized, it is necessary to measure what the proportion of anatase type titanium dioxide structure is to exist in the nano-scaled titanium dioxide powder (Step 130). I should be sure whether the nano-scaled titanium dioxide powder has the specified proportion of anatase type titanium dioxide structure (Step 140). The specified or predetermined proportion as described previously depends mainly on conditions of the environment.

If the proportion of the anatase type titanium dioxide structure in the nano-scaled titanium dioxide powder is not met, then method of the present invention will return to step 120 to obtain the required nano-scaled titanium dioxide powder over again. Otherwise, if the target proportion is met, then the calcium phosphate series ceramic material is mixed with the nano-scaled titanium dioxide powder so as to manufacture a mixture. The mixture is also called the batch material (Step 150).

When the calcium phosphate series glass ceramic material is mixed with the nano-scaled titanium dioxide powder, a plurality of zirconium dioxide (ZrO₂) grinding balls are used as mixing media. Preferably, these zirconium dioxide grinding balls have diameters at about 10 mm. Meanwhile, according to the embodiment of the present invention, the zirconium dioxide (ZrO₂) grinding balls are used to grind the calcium phosphate series glass ceramic material and the nano-scaled titanium dioxide powder for 20 hours so that the calcium phosphate series glass ceramic material and the nano-scaled titanium dioxide powder can be completely mixed.

Subsequently, the mixture is baked (step 160), preferably for 20 hours in the temperature of 150° C. Then, the mixture (batch material) is placed at a platinum crucible and heated to a high temperature until the mixture is in a melt state. The mixture in the melt state is then removed from the platinum crucible to be placed at a graphite board for quenching (step 170). After quenching, the mixture is transferred to form a bioglass. Preferably, the mixture is further annealed so that the bioglass with better mechanical properties can be formed (Step 180). Moreover, when the mixture is annealed, the mixture is annealed for 3 hours in a temperature of about 400° C. so that an amorphous bioglass can be formed.

After the bioglass is formed, the bioglass is further ground into a bioglass powder (step 190). Meanwhile, to keep diameters of the bioglass powder within a range of specified sizes, part of the bioglass powder with specified diameter can be screened out by meshing. According to the present invention, it is recommended that meshes numerated from No. 200 and 325 can be chosen to screen out the bioglass powder with the specified diameters (step 210).

The bioglass powder with the specified diameters is then placed into a specific mold for dry casting (step 220). Then, the molded biomedical glass powder is subjected to a heat treatment for sintering and thus being recrystallized so as to obtain the bioactive glass ceramic material or block (step 230).

Finally, when the bioactive glass ceramic material is applied in a clinical treatment, the bioactive glass ceramic material is can be applied into an electric field (or a dynamic changed magnetic field) for polarizing the bioactive glass ceramic material (step 240). In this light, the bioactive glass ceramic material is electrified so that a biomedical electrified glass ceramic material can be obtained (step 250).

To prove that the present invention is indeed provided with the performance described above, the inventor further processes various measurements and tests on the bioactive glass ceramic material and the biomedical electrified glass ceramic material for some specific physical properties, such as properties in the mechanical strength, in electricity, and in biology.

Firstly, the biomedical glass, the bioactive glass ceramic material and the biomedical electrified glass ceramic material are respectively subjected to the X-ray analysis, the plating process and the thermal analysis so as to obtain data such as the composition of glass ceramic, the surface structure, the glass transition temperature, the phase change temperature, and etc. Upon analyzing these test data, the environmental parameters (such as the heating temperature, the operation pressure and the time duration) for the heat treatment described above can be preferably adjusted.

Secondly, regarding the mechanical (strength) properties, the biomedical glass, the bioactive glass ceramic material and the biomedical electrified glass ceramic material are respectively subjected to detections and measurements in hardness, compactness, density, and porosity or destructive tests such as the bending strength test, the compression strength test and the impact test. After the destructive tests, the internal crystal phase analyses can be performed on the destructive cross section by a scanning electron microscope (SEM) or a transmission electron microscope (TEM).

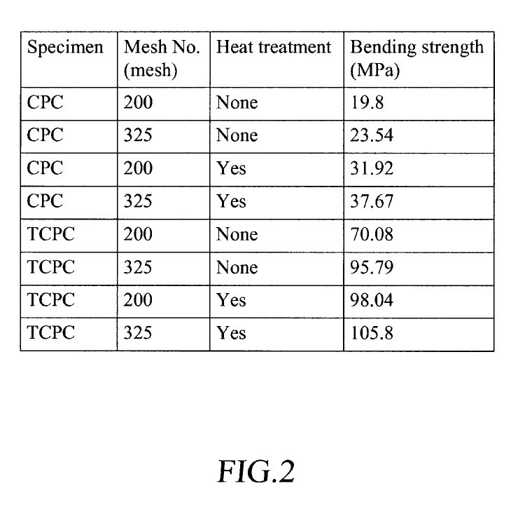

To prove that the ceramic glass of the present invention can provide better mechanical strengths than that of the prior art, data of the bending strength test is illustrated in FIG. 2. As shown, a comparison table of the bending strength between the bioactive glass ceramic material (calcium phosphate glass ceramic material) of the prior art and the bioactive glass ceramic material (a calcium phosphate series ceramic material with anatase type titanium dioxide structure) of the present invention is listed. In FIG. 2, following finding can be ensured.

1. The bioactive glass ceramic material (including a calcium phosphate series ceramic material with anatase type titanium dioxide structure) of the present invention has a higher bending strength than that of the bioactive glass ceramic material (including a calcium phosphate series ceramic material without anatase type titanium dioxide structure).

2. The bioactive glass ceramic material prepared by the heat treatment has a higher bending strength than that of the bioactive glass ceramic material without a heat treatment.

3. The biomedical glass powder screened by the mesh No. 325 has a higher bending strength than that of the biomedical glass powder screened by the mesh No. 200.

As described above, from experimental data in FIG. 2, it is noted that, when the test conditions are identical, the bending strength of the bioactive glass ceramic material of the present invention is two (2) to four (4) times of that of the prior art. Obviously, after the bioactive glass ceramic material of the present invention can provide better strength performance to the broken bone.

Thirdly, regarding the electrical properties, before and after the bioactive glass ceramic material and the biomedical electrified glass ceramic material are respectively polarized, the bioactive glass ceramic material and the biomedical electrified glass ceramic material are subjected to measurement of electrical properties such as the dielectric constant, the dielectric loss, the resonant impedance, the capacitance, the resonance frequency. To explain how the bioactive glass ceramic material of the present invention is much easier to be polarized, half-done-in-manufacturing samples (including calcium phosphate glassiness with titanium dioxide) of the bioactive glass ceramic material after and before polarization are subjected to measurements of the dielectric constant.

Before the bioactive glass ceramic material is polarized, a silver conductive paste is applied to a surface of a specimen as an electrode of the charging process. A strong electric field is applied through a piezoelectric sensor so that an electronic dipole is aligned along the direction of the electric field during the polarization process. In this experiment, the specimen is placed into a silicone oil at the temperature of 120° C. and subjected to an external voltage up to 4KV/mm, and the duration of the polarization process is about 30 minutes.

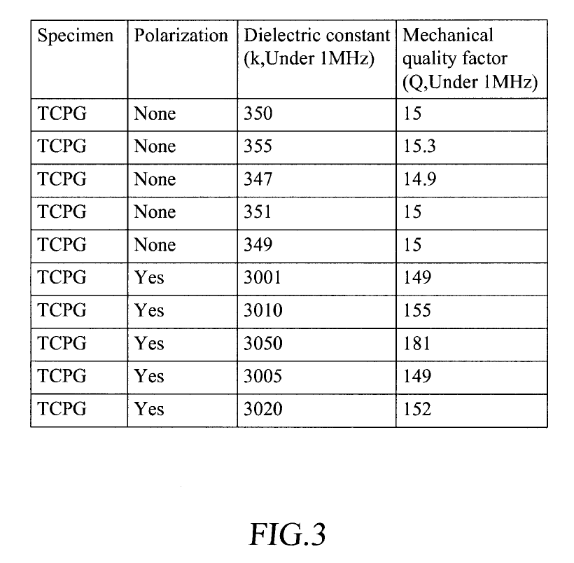

Referring to FIG. 3, it illustrates a comparison table of dielectric constants and mechanical properties of the bioactive glass ceramic material (calcium phosphate glassiness with titanium dioxide) of the present invention. The dielectric constants and the mechanical quality factors respectively present data corresponding to both the polarized and non-polarized bioactive glass ceramic material. As shown in FIG. 3, when the frequency is 1 MHz, the average dielectric constant of the non-polarized the calcium phosphate glass with titanium dioxide is about 3.51×10², while the average dielectric constant of the polarized the calcium phosphate glass with titanium dioxide is about 3.02×10³ which is 8˜9 times higher than that of the non-polarized calcium phosphate glass. Obviously, when the bioactive glass ceramic material is polarized into a biomedical electrified glass ceramic material, its polarization is significant and thus its ability in carrying electric charge is substantially increased.

Regarding the biological property, the biomedical electrified glass ceramic material is placed in a tissue fluid or transplanted into an animal body for a variety of tests for a weight loss ratio, a release amount of calcium ion (Ca²⁺) and a release amount of phosphate ion (PO₄³⁻). According to these tests, the bone recovery after the biomedical electrified glass ceramic material is transplanted into the human body can be assessed.

In the weight loss ratio, it is understood that the bioactive glass ceramic material with titanium dioxide of the present invention can react with inorganic ions of the tissue fluid. In addition, in the test, the biomedical electrified glass ceramic material has been placed in the tissue fluid for a week, and so an apatite layer with titanium dioxide accrues and the weight loss is then decreased. The apatite layer with titanium dioxide can accrue on a surface of the calcium phosphate glass with titanium dioxide in more expedite way by the polarization process of an external electric field. Furthermore, the cell specimen is produced by a specific cell cultivation for this experiment. Through the specific cell survival (MTT) assay and cell types, it helps to assess how well the present invention is helpful to the bone recovery.

Regarding to cell survival (MTT) assay, the survival rate is determined by evaluating the blue formazan crystals metabolized by the mitochondria of the living cells. During cell survival (MTT) assay, both the bioactive glass ceramic materials including the calcium phosphate glass without titanium dioxide of the prior art and the calcium phosphate glass with titanium dioxide of the present invention are tested.

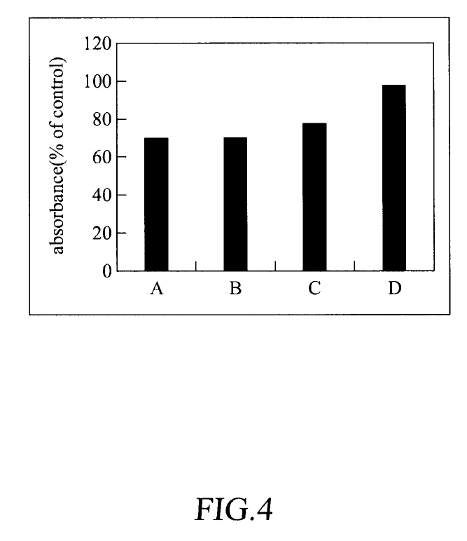

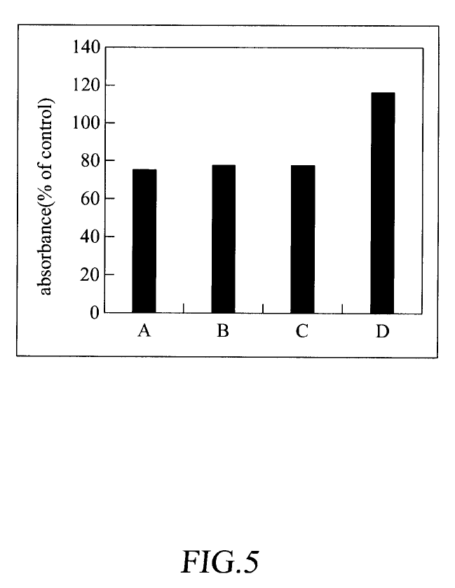

Referring to FIGS. 4 and 5, FIG. 4 illustrates a comparison table of the cell survival rates between the present invention and the prior art. As to FIG. 4, by comparing the prior art, the biomedical electrified glass ceramic material is subjected to the cell survival (MTT) assay after four hours. FIG. 5 illustrates another comparison table of the cell survival rates between the present invention and the prior art. As to FIG. 5, by comparing the prior art, the biomedical electrified glass ceramic material is subjected to the cell survival (MTT) assay after 96 hours. The cell survival (MTT) assay begins after the cell cultivation is implemented. Before the cell survival (MTT) assay, four specimens are provided as the following: (A) a non-polarized calcium phosphate glass without titanium dioxide of the prior art; (B) a polarized calcium phosphate glass without titanium dioxide of the prior art; (C) a non-polarized calcium phosphate glass with titanium dioxide of the present invention; and (D) a polarized calcium phosphate glass with titanium dioxide of the present invention.

As shown in FIG. 4, after four hours under the same experimental conditions, the polarized calcium phosphate glass with titanium dioxide of the specimen (D) has a higher cell survival rate than that of specimens (A), (B) and (C). Similarly, after 96 hours under the same conditions, the polarized calcium phosphate glass with titanium dioxide of the specimen (D) has a higher cell survival rate than that of specimens (A), (B) and (C). Obviously, from the cell survival (MTT) assay, the cell including the calcium phosphate glass with titanium dioxide of the present invention has a better adaptation and can speed up the cell growth.

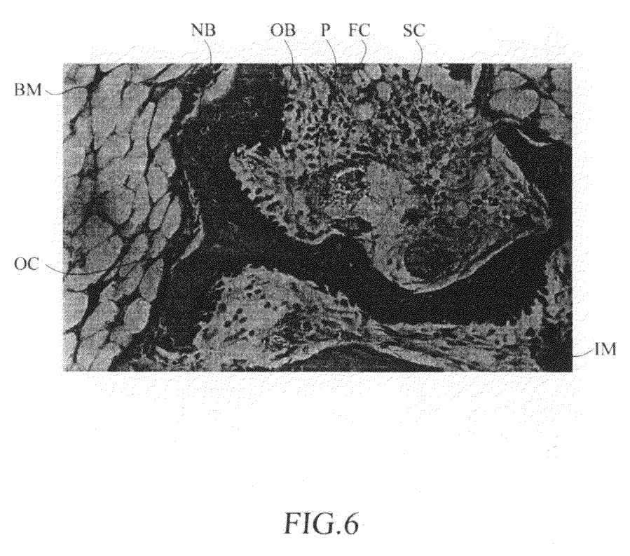

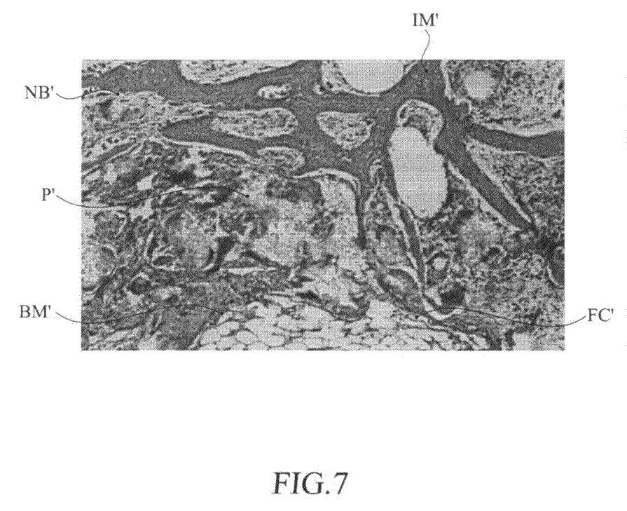

Finally, referring to FIGS. 6 and 7, FIG. 6 illustrates an embodiment of the present invention showing how the bone grows and recovers since the non-polarized bioactive glass ceramic material has been transplanted into rabbit's body. FIG. 7 illustrates another embodiment of the present invention showing how the bone grows and recovers since the polarized bioactive glass ceramic material has been transplanted into rabbit's body. In these two examples, the bioactive glass ceramic material of the present invention can be calcium phosphate glass with titanium dioxide.

As shown in both FIG. 6 and FIG. 7, the BM represents a bone marrow; the FC represents fat cells; the IM represents where the bioactive glass ceramic material is implanted; the P represents granule of the non-polarized calcium phosphate material with titanium dioxide; the NB represents newborn osteocytes; the OB represents osteoblasts; the OC represents osteocytes; and, the SC represents interstitial cells. The non-polarized calcium phosphate material with titanium dioxide is implanted into rabbit's tibia located near and beneath the patella tendon insertion by 0.5 cm. The neighboring area of the implanted non-polarized calcium phosphate material is dyed and enlarged by 200 times. It is readily viewed that quite a few osteoblasts are aligned along the rim of the newborn osteocytes in a typical shape of cuboid. It also shows that a bone formation process (osteogenesis) is vigorously progressed. The bone cells of the newborn osteocytes are crisp clear, and it implies that the bone mineralization has not yet been complete.

In FIG. 7, the polarized calcium phosphate material with titanium dioxide is implanted into rabbit's femur located away from and beneath the medial collateral ligament insertion by 0.5 cm. The neighboring area of the implanted non-polarized calcium phosphate material is dyed and enlarged by 100 times. It shows that, in FIG. 7, the bone formation process (osteogenesis) is vigorously progressed and a loss of calcium phosphate glass with titanium dioxide decreases due to its polarization. It is also shown that a new bone is grown in the neighboring area of the implanted non-polarized calcium phosphate material.

To sum up, regarding the mechanical (strength) properties in particular the bending strength, experiment shows that bending strength of the bioactive glass ceramic material of the present invention is approximately two (2) to four (4) times of that of the prior art. Thus, after the bioactive glass ceramic material of the present invention is implanted into the human body, the bioactive glass ceramic material can promote the growth of the broken bone and thereby the bone recovery can be expedited.

Furthermore, regarding the biological property, in particular the growth of the broken bone, after the anatase type titanium dioxide structure of the bioactive glass ceramic material is polarized, the bioactive glass ceramic material is charged. As previously shown, a bone graft made of the bioactive glass ceramic material can be transplanted into the human body and thereby can speed up the growth of the broken bone. Thus, the time to recovery can be substantially shortened.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A method for manufacturing a bioactive glass ceramic material, comprising the steps of:
(a) providing a calcium phosphate series glass ceramic material;
(b) providing a nano-scaled titanium dioxide powder with a predetermined proportion of anatase type titanium dioxide structure;
(c) mixing the calcium phosphate series glass ceramic material with the nano-scaled titanium dioxide powder according to a predetermined mixing proportion so as to manufacture a mixture;
(d) melting and quenching the mixture so as to form a bioactive glass;
(e) grinding the bioactive glass to manufacture a bioactive glass powder; and
(f) applying a predetermined heat treatment upon the bioactive glass powder so as to manufacture the bioactive glass ceramic material.

2. The method as claimed in claim 1, wherein the calcium phosphate series ceramic material of the step (a) is manufactured by mixing a calcium oxide (CaO), a phosphorus pentoxide (P₂O₅) and a phosphoric acid (H₃PO₄).

3. The method as claimed in claim 1, wherein the step (b) further comprises a step (b1) of ensuring whether the nano-scaled titanium dioxide powder contains the predetermined proportion of the anatase type titanium dioxide structure.

4. The method as claimed in claim 1, wherein a plurality of zirconium dioxide (ZrO₂) grinding balls are used as mixing media for the step (c).

5. The method as claimed in claim 1, wherein the step (c) uses the zirconium dioxide (ZrO₂) grinding balls to grind the calcium phosphate series glass ceramic material and the nano-scaled titanium dioxide powder for about 20 hours.

6. The method as claimed in claim 1, wherein the step (c) further comprises a step (c1) of baking the mixture.

7. The method as claimed in claim 6, wherein the step (c1) further includes to bake the mixture for 20 hours in a temperature of 150° C.

8. The method as claimed in claim 1, wherein the step (d) further comprises a step (d1) of annealing the mixture after the mixture is melt and quenched.

9. The method as claimed in claim 8, wherein the step (d1) is operated in an ambient temperature of about 400° C. for 3 hours.

10. The method as claimed in claim 1, wherein the step (e) further comprises a step (e1) of screening out the bioactive glass powder with a predetermined granule diameter.

11. The method as claimed in claim 10, wherein the step (e) further comprises a step (e2) of dry-casting the bioactive glass powder of the step (e1).

12. The method as claimed in claim 1, wherein the method further comprises a step (g) of polarizing the bioactive glass ceramic material so as to obtain a electrified bioactive glass ceramic material.

13. The method as claimed in claim 12, wherein the step (g) implements an electric field to polarize the bioactive glass ceramic material.
